(19) United States
(12) Patent Application Publication
(10) Pub. No.: US 2009/0091118 A1
(43) Pub. Date: Apr. 9, 2009

(54) Display and Storage Album for Pop-up Cards

(76) Inventor: Ray David Marshall, Oakland, CA (US)

Correspondence Address: JAMES R. CYPHER, 405 14TH STREET, SUITE 1607, OAKLAND, CA, 94612, US

(21) Appl. No.: 12/248,013

(22) Filed: Oct. 8, 2008

Related U.S. Application Data
(60) Provisional application No. 60/978,360, filed on Oct. 8, 2007.

(51) Int. Cl. B42D 3/00; B42D 5/00; B42D 17/00

(52) U.S. Cl. 281/29; 281/38; 281/49; 281/45

(57) ABSTRACT

A pop-up card stored in the album, the pop-up card having a pair of leaves joined by a vertical hinge and each leaf of the card has an outside edge, and each outside edge of each leaf is either inserted into the pocket in the outside edge of a page or a cover of the album, with the pockets receiving the leaves of the cards being on facing page sides of pages in the album or a page and an inside cover of the cover, and each pop-up card stored in the album has an element attached to or connected to one or more of the leaves of the card that moves or can be moved by the user and that movement is in addition to the swinging action of the opening of the leaves of the card on the hinge between the leaves.

### BACKGROUND OF THE INVENTION

This invention relates generally to an apparatus and method of holding and displaying pop-up cards, and more particularly an album that allows cards to be preserved and displayed without having to remove them from the album.

The invention provides a means for preserving and cataloging paper-engineered cards or pop-up cards together so they can be viewed as desired, much like photographs in a photo album.

The present intention provides an album, having pages for holding cards, with each page having a transparent overlay along its outer edge on both sides of the page into which the outer edges of the covers of card can be inserted. The pages are bound in such a manner that a card, comprising two covers or leafs joined by a vertical fold, which are generally the same size as each other, but need not be, can have its covers inserted into the overlays along the edges of two facing pages of the album such that the card is retained in the album. The covers of an opened card when inserted into the overlays of facing pages of the album hold the card in the album in such a manner that the card can be opened and the card's pop-up can be actuated while the card is stored in the album. The spread of the book can hold the pop-up card open in the “pop-up” position.

### SUMMARY OF THE INVENTION

It is an object of the present invention to provide an apparatus for storing and preserving pop-up cards. It is a further object of the present invention to provide an apparatus for displaying pop-up cards where the cards do not have to be removed from the album to view the pop-up.

It is a further object of the present invention to provide an apparatus where the cards may be easily removed and returned to the album.

The present invention fulfills the above objects by providing an album that has front and back covers connected by a binder, having means for retaining a plurality of pages or spreads between the covers, each page or spread having at least one overlay attached to each side of the page near the outside edge of the page to form a pocket or sleeve designed to retain a cover or leaf of the card. Thus a page or spread having two sides and overlay attached to the outside edges of the page or spread on both sides would have four pockets for receiving the covers of cards.

Each page or spread may be secured between the front and back covers of the album by various means, although it is desirable that the facing pages open as similarly to the card being stored in the book as possible.

Multiple cards could be stored and fully displayed on a single page, if the pages are made tall enough in comparison to the cards.

### BRIEF DESCRIPTION OF THE DRAWINGS

FIG. 1 is a perspective view of the album of the present invention.

FIG. 2 is a sectional top view of the album of the present invention.

FIG. 3 is a top plan view of the front and back covers of the album of the present invention.

FIG. 4 is a bottom plan view of the front and back covers of the album of the present invention.

FIG. 5 is a top plan view of joined pages or spreads of the album of the present invention.

FIG. 6 is a partial exploded view of the front and back coves of the album of the present invention.

FIG. 7 is a partial exploded view of joined pages or spreads of the slbum of the present invention.

FIG. 8 is an exploded view of the album of the present invention.

FIG. 9 is plan view of the present invention, showing a pop-up card being inserted into facing pages of the present invention.

FIG. 10 is perspective view of the present invention, showing a pop-up card being inserted into facing paces of the present invention.

FIG. 11 is a perspective view of the present invention, showing a pop-up card held in an album for receiving pop-up cards.

FIG. 12 is an alternate embodiment of the present invention.

FIG. 13 is an alternate embodiment of the present invention.

FIG. 14 is a perspective view of a pop-up card. The card is partially closed.

FIG. 15 is a perspective view of a partially opened pop-up card.

FIG. 16 is a perspective view of a partially opened pop-up card.

FIG. 17 is a plan view of an alternate, opened pop-up card, having two pop-up elements.

FIG. 18 is a plan view of an alternate, opened pop-up card, having two pop-up elements.

FIG. 19 is a plan view of an alternate, opened pop-up card, having two pop-up elements.

### DETAILED DESCRIPTION OF THE INVENTION

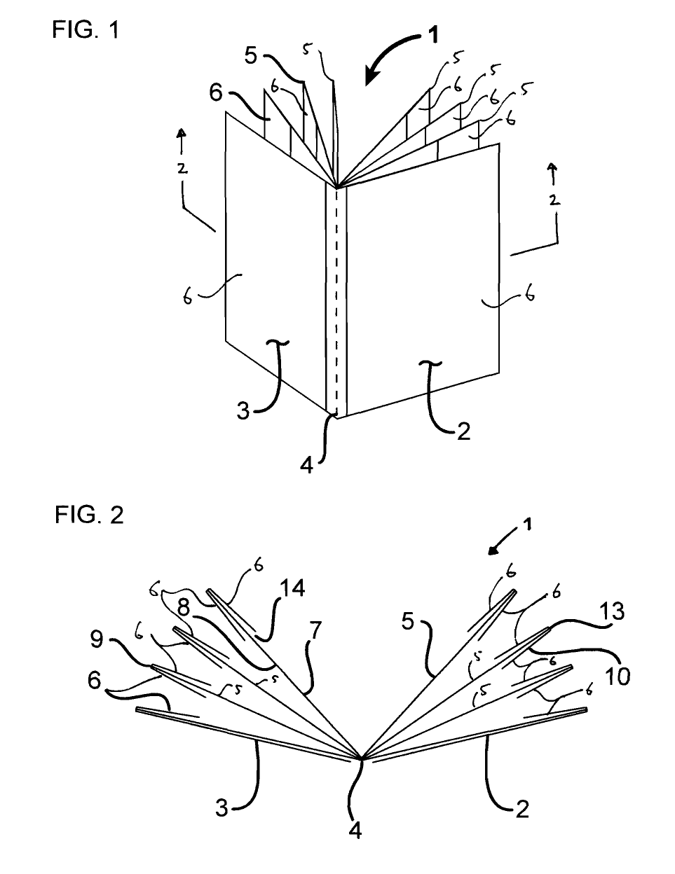

As shown in FIGS. 1 and 2, the album 1 is shown containing a front cover 2 and a back cover 3 connected thereto by a binder section or spine 4. The binder section 4 has means for retaining the pages or spreads 5 contained between the covers 2 and 3. The pages or spreads 5 of the album 1 contain sleeve pockets 6, preferably on each side 7 and 8 of the page 5 at the outer edges 9 of the pages 5, which are preferably made by means of an overlay 10 attached to each album page 5 at its top edge 11, bottom edge 12 and outer edge 13. The overlay 10 is openable at the inner edge 14 to form a sleeve pocket 6 for holding the leaf or cover 16 of a greeting card 17. Preferably, the overlay 10 is relatively narrow compared to the width 18 of the card leaf 16 that it will contain and the page 5 of which it is a part, such that there is room for allowing the paper-engineered portion 19 of the card 17 to operate.

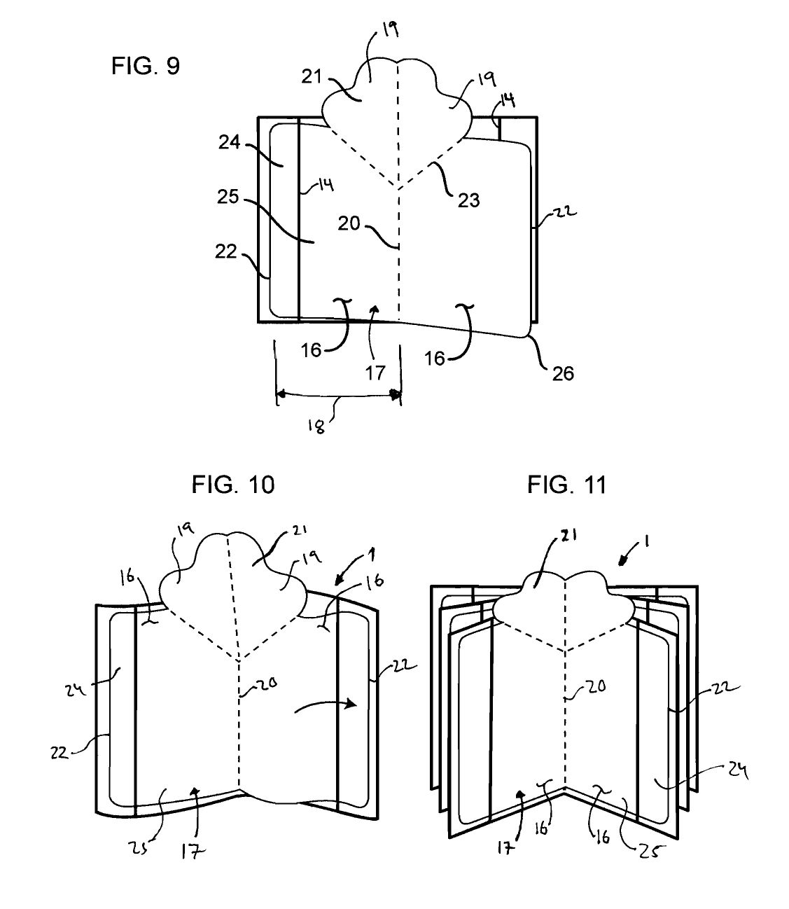

As shown in FIG. 9, preferably, each page 5 of the album 1 is made of transparent plastic to facilitate displaying and reading the card 17 without having to remove the card 17.

Pockets 6 and pages 5 made from plastic can be joined by heat or sonic sealing techniques. Preferably, the spread or pages 5 are sonically sealed to the vertical spine 4 of the album 1.

As shown in FIG. 9, preferably, the pages or spreads 5 are bound in such a manner that a card 17, comprising two covers or leafs 16 joined by a vertical fold 20, with the leaves 16 being generally the same size as each other, but need not be, can have its leaves 16 inserted into the overlays 10 along the edges 9 of two facing page 5 side faces 7 and 8 or an inside cover 2 or 3 face 7 or 8 and a facing page 5 side face 7 or 8 of the album 1 such that the card 17 is retained in the album 1 by both its leaves 16. The covers or leaves 16 of an opened card 17 when inserted into the overlays 10 of facing page 5 side faces 7 and 8 of the album 1 hold the card 17 in the album 1 in such a manner that the card 17 can be opened and the card's pop-up 21 can be actuated while the card 17 is stored in the album 1. When the album 1 is closed the pop-up cards 17 stored in the album 1 are closed. When the pages 5 of the album 1 are turned, one pop-up card 17 is closed, and another, if present is opened.

Preferably, each pop-up card 17 stored in the album 1 has a pair of leaves 16 joined by a vertical hinge 10 and each leaf 16 of the card 17 has an outside edge 22, and each outside edge 22 of each leaf 16 is either inserted into the pocket 6 in the outside edge 9 of a page 5 or a cover 2 or 3 of the album 1, with the pockets 16 receiving the leaves 16 of the cards 17 being on facing page sides 7 and 8 of pages 5 in the album 1 or a page 5 and an inside cover 7 or 8 of the cover 2 or 3. Furthermore, each pop-up card 17 stored in the album 1 has at least one element 21 attached to or connected to one or more of the leaves 16 of the card 17 that moves or can be moved by the user and that movement is in addition to the swinging action of the opening of the leaves 16 of the card 17 on the hinge 20 between the leaves 16. Each card has a pair of leaves 16 defined by a hinge 20 and an additional, moveable element 21 attached to one or more of the leaves 16 of the card 17. The moveable element 21 can have a hinge 23 that is separate from the hinge 20 that defines the leaves 16 of the card 17. The moveable element 21 can have a point of rotation around which it moves. The moveable element 21 can slide in relation to the leaves 16 of the card 17. The moveable element 21 can be a combination of the above-described elements. The moveable element 21 can be attached to the leaves 16 of the card 17 by an adhesive or a mechanical flap. It can receive in a slit in the leaves 16. The leaves 16 can comprise multiple layers of material joined together in certain areas. The moveable element 21 can be made from the same material as the leaves 16 of the card 17, but have additional hinge elements 23 that are actuated when relative movement on the hinge 20 that defines the leaves 16 is actuated. The materials that make up the leaves 16 and moveable element 21 of the card 17 are preferably suitable paper or paper-weight material; however, it could alternatively be any suitable fabricated sheet material, such as thermoplastic material.

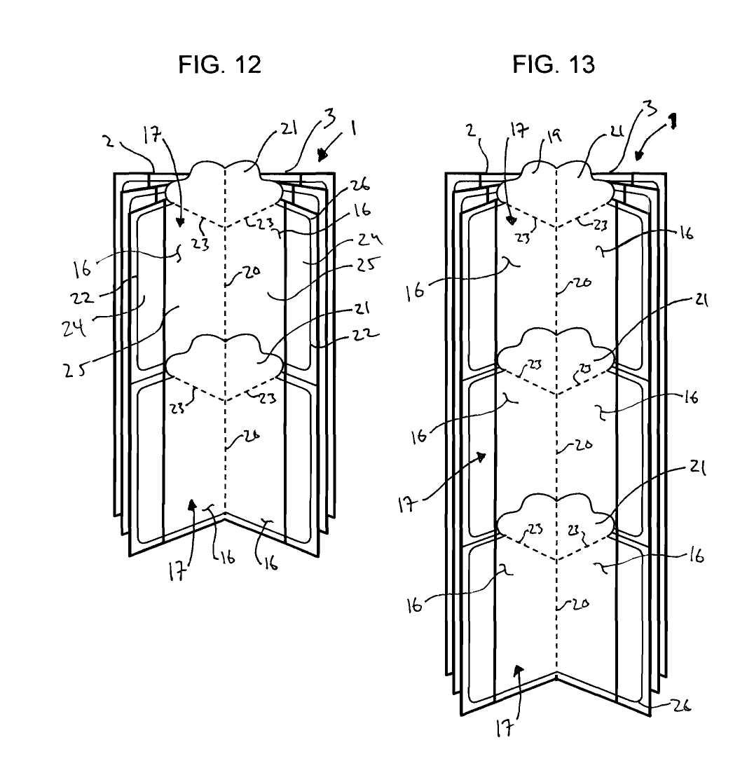

As shown in FIGS. 12 and 13, pages 5 in the album 1 could be made to hold a plurality of cards 17 by making the pages 5 tall enough to receive more than one card 17. The pages 5 could be divided by sealing the overlay 10 horizontally at a line that would fall between the cards 17. Preferably the front and back covers 2 and 3 of the book 1 are 3.5″ wide by 5″ tall. Each spread or page 16 is 3.5″ wide by 5″ tall. Overlays 10 for forming pockets or sleeves 6 formed on pages 5 or covers 2 of 3 for holding pop-up cards 17 are preferably 1″ wide by 5″ tall. The overlay 10 is placed over the outside portion 24 of the leaf 16 at the outside edge 22 of the leaf, such that the inside portion 25 of the leaf 16 which would be approximately 2.5″ inches in the preferred embodiment that is uncovered and is made available for the engineered portion 19 of the pop-up card 17 to operate.

In the preferred embodiment, pop-up cards 17 designed to fit in the album 1 would be 3.375″ wide by 4.75″ tall, and corners 26 of cards 17 would have a 0.25″ radius cut to aid insertion in the pockets 6.

Any type of pop-up card 17 can be inserted into the album 1 and viewed in its fully-actuated position, provided the overlay 10 does not interfere with the card's 17 operable or actuated elements 21.

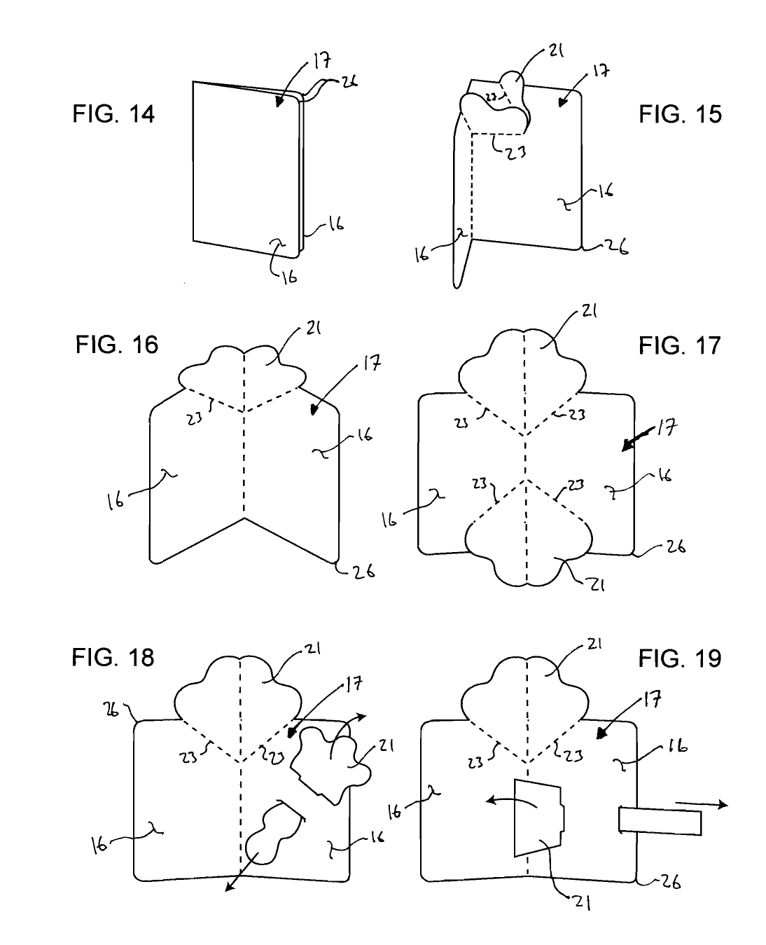

As shown in FIGS. 14 through 19, pop-up cards 17 that can be used with the album 1 include cards 17 with pull tabs, where the user pulls a tab connected to a sheet that is divided into multiple sections by a hinge, and when the tab is pulled the hinge is actuated, causing a portion of the sheet to swing out of the plane of the card. Such pop-up cards 17 also include cards with lift flaps. The simplest lift flap card has a sheet that is connected to the card and the sheet has a hinge that the user can turn the flap on the hinge to see underneath the lift flap. More complicated lift flaps can also be connected to the card 17, with the lifting of the flap causing a sliding operation of the sheet which causes lateral movement on the other side of the hinge from the sheet.

The page or spreads 5 and overlays 10 are preferably made of transparent plastic—115 mil polypropylene. Also, preferably the pockets 6 are formed by heat or sonically sealing the top, bottom and outer edges of the overlays to the spreads or pages 5, leaving the inner edge of the overlay 10 open to insert a cover 16 of a greeting card 17.

The album 1 could have a spiral binding, glue binding, an openable ring binding, a peg binding or other binding methods known in the trade. Bindings 4 which would allow for the addition or subtraction of pages 5 as needed may be desirable.

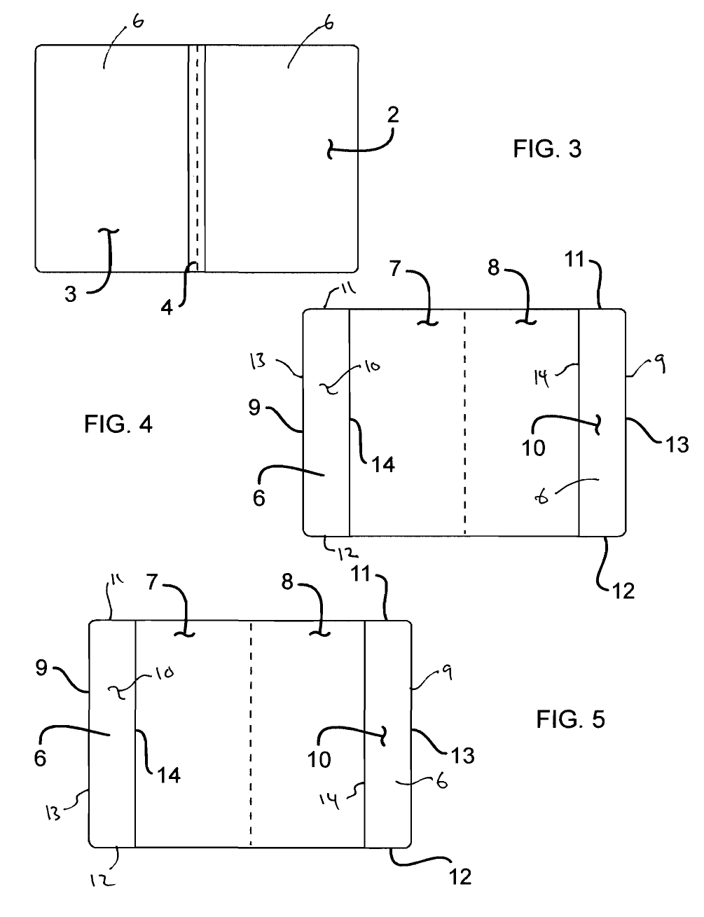

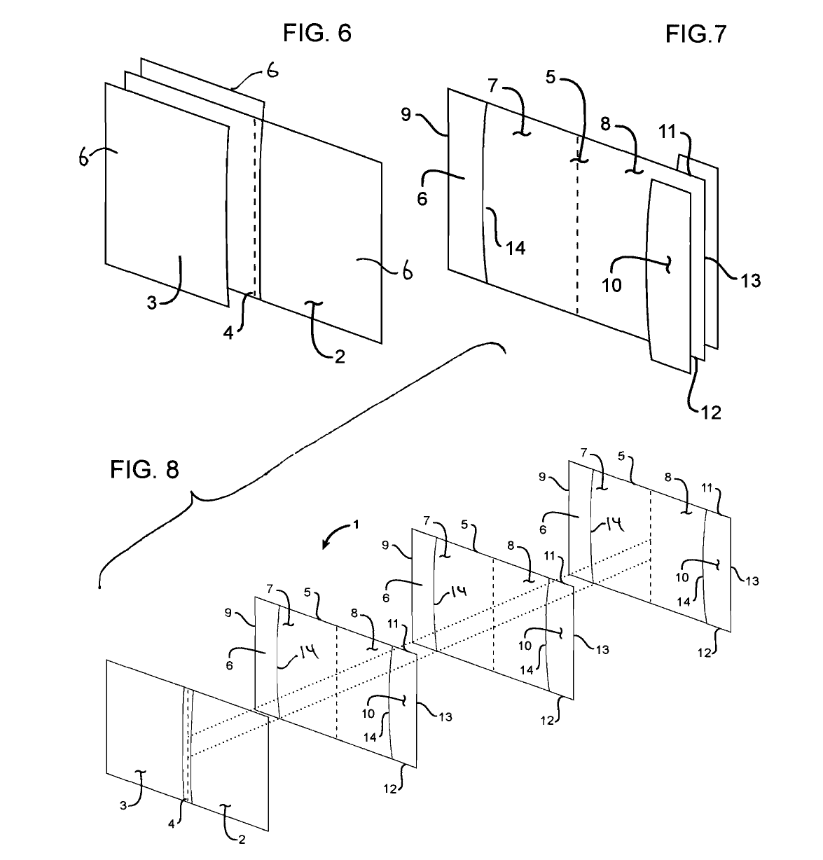

As shown in FIGS. 3 and 4, the cover 2 or 3 can be made with pockets 6 in a similar fashion to the spreads or pages 5. The covers 2 and 3 of the album 1 can have sleeve pockets 6, preferably on each side 7 and 8 of the front and back covers 2 and 3, which are preferably made by means of an overlay 10 attached to each side 7 and 8 of the first and second covers 2 and 3 at their top edges 11, bottom edges 12 and outer edges 13. The overlays 10 are openable at the inner edge 14 to form a sleeve pocket 6 for holding the leaf or cover 16 of a greeting card 17 or some other sheet.

Preferably, for the inside faces 7 and 8 of the front and back covers 2 and 3, the overlays 10 are relatively narrow compared to the width of the covers 2 and 3, such that there is room for allowing the paper-engineered portion 21 of a card 17 stored in the sleeve in the cover 2 or 3 to operate. Preferably, for the outside faces 7 and 8 of the covers 2 and 3, the overlays 10 are relatively wide compared to the width of the covers 2 and 3, such that a title page or description sheet can be placed in the pockets 6 in the outside covers 2 and 3 and be protected and not risk being lost.

I claim:

1. A combination of an album and one or more pop-up cards received in said album, said combination comprising:
a. said album having a front cover and a back cover, said back cover being connected to said front cover by a spine;
b. said album having at least two sleeve pockets;
c. one or more pop-up card received in said sleeve pockets, each of said one or more pop-up cards having two leafs joined by a hinge, wherein:
d. each of said one or more pop-up cards has an actionable pop-up element attached to one or more of the leaves of each of the pop-up cards, each of said actionable pop-up elements being able to move when the one or more pop-up cards is received in the album, and the actionable pop-up element moves in addition to the swinging action of the opening of the leaves of the one or more pop-up cards on the hinge between the leaves of the one or more pop-up cards.

2. The combination of claim 1; wherein:
a. said front and back covers are formed with sleeve pockets; and
b. leaves of said one or more pop-up cards are received in said sleeve pockets of said front and back covers.

3. The combination of claim 2; wherein:
said sleeve pockets are formed from overlays attached to said first and second covers of said album.

4. The combination of claim 1, further comprising:
a. one or more pages contained in the album and connected to said first and second covers;
b. said one or more pages also containing sleeve pockets that can receive the leaves of said one or more pop-up cards received in the album.

5. The combination of claim 4, wherein:
said one or more pages contained in the album are connected to the spine that connects the front and back covers.

6. The combination of claim 1, wherein:
said pockets are located at the outer edges of the one or more pages and the outer edges of the front and back covers.

7. The combination of claim 1, wherein:
the sleeve pockets are made by means of one or more overlays attached to each of the front and back covers.

8. The combination of claim 4, wherein:
the pockets are made by means of overlays attached to the one or more pages.

9. The combination of claim 7, wherein:
the one or more overlays each have a top edge, a bottom edge and an outer edge, and each one or more overlay is attached at the top edge, bottom edge and outer edge of the overlay.

10. The combination of claim 8, wherein:
the one or more overlays each have a top edge, a bottom edge and an outer edge, and each one or more overlay is attached to a page at the top edge, bottom edge and outer edge of the overlay.

11. The combination of claim 9, wherein:
the one or more overlays have an inner edge, and the one or more ovelays are openable at the inner edge to form a sleeve pocket for holding the leaf or cover of the one or more pop-up cards.

12. The combination of claim 10, wherein:
the one or more overlays have an inner edge, and the one or more overlays are openable at the inner edge to form a sleeve pocket for holding the leaf or cover of the one or more pop-up cards.

13. The combination of claim 11, wherein:
the one or more overlays are relatively narrow compared to the width of the leaf of the pop-up card that each overlay holds.

14. The combination of claim 12, wherein:
the one or more overlays are relatively narrow compared to the width of the leaf of the pop-up card that each overlay holds.

15. The combination of claim 13, wherein:
a. said leaves of said one or more pop-up cards are each formed with an outside edge, and inside portion and outside portion, and the actionable pop-up element is located on said inside portion of the leaf; and wherein:
b. each of said one or more overlays are placed over the outside portion of the leaf at the outside edge of the leaf, such that the inside portion of the leaf is uncovered and is made available for the actionable pop-up element of the pop-up card to operate.

16. The combination of claim 14, wherein:
a. said leaves of said one or more pop-up cards are each formed with an outside edge, and inside portion and outside portion, and the actionable pop-up element is located on said inside portion of the leaf; and wherein:
b. each of said one or more overlays are placed over the outside portion of the leaf at the outside edge of the leaf, such that the inside portion of the leaf is uncovered and is made available for the actionable pop-up element of the pop-up card to operate.
